(19) United States
(12) Patent Application Publication
(10) Pub. No.: US 2025/0055377 A1
(43) Pub. Date: Feb. 13, 2025

(54) POWER CONVERSION DEVICE AND MAGNETIC ASSEMBLY

(71) Applicant: SHANGHAI METAPWR ELECTRONICS CO., LTD, Shanghai (CN)

(72) Inventor: Jianhong ZENG, Shanghai (CN)

(73) Assignee: SHANGHAI METAPWR ELECTRONICS CO., LTD, Shanghai (CN)

(21) Appl. No.: 18/798,780

(22) Filed: Aug. 8, 2024

(30) Foreign Application Priority Data
Aug. 13, 2023 (CN) 202311012946.5

(51) Int. Cl. H02M 3/335; H01F 27/00; H02M 1/00; H02M 1/088

(52) U.S. Cl. CPC H02M 3/33571; H01F 27/006; H02M 1/088; H02M 3/33576; H02M 1/0054

(57) ABSTRACT

A power conversion device and a magnetic assembly are provided. The power conversion device and the magnetic assembly are applied to a circuit topology aiming at the application of an input voltage to an output voltage high-voltage-reduction ratio. The circuit topology has low switching loss and high conversion efficiency in a high-frequency switching occasion of a power switch. The device layout setting of the power conversion device and the winding mode of the transformer are provided, the size of the power conversion device is reduced, and the steady-state performance and the dynamic performance of the conversion device are improved.

### CROSS-REFERENCE TO RELATED APPLICATION

This application claims the priority benefit of China application no. 202311012946.5, filed on Aug. 13, 2023. The entirety of the above-mentioned patent application is hereby incorporated by reference herein and made a part of this specification.

### BACKGROUND

With the development of artificial intelligence, the power requirements of an intelligent data processing chip, such as a GPU/CPU NPU and the like (collectively referred to as XPU) are higher and higher, so that the power of the server is greatly increased, the input voltage of the server gradually changes from 12V to 48V, and the working voltage of the XPU becomes lower and lower along with the progress of the process and gradually moves from 0.8V to 0.65V. Therefore, the step-down ratio of the input voltage to the output voltage is higher and higher, and in order to obtain high 48V input-to-0.65 V output conversion efficiency, a circuit architecture with high conversion efficiency is urgently needed.

Aiming at the solution of a 48V input and 0.8V voltage-stabilized output power conversion device, the input ends of the primary half-bridge units are connected in series, and the output ends of the primary-side half-bridge units are connected in parallel, so that the input voltage of each half-bridge unit is reduced, the switching loss of the power switch devices in each half-bridge unit under high-frequency switching is reduced, and the conversion efficiency of the overall power conversion device is improved.

### SUMMARY

In view of the above, one of the objectives of the present invention is to provide a power conversion device and a magnetic assembly. The power conversion device and the magnetic assembly are applied to a circuit topology suitable for use in the application of an input voltage to an output voltage high step-down ratio. The circuit topology has low switching loss and high conversion efficiency in the case of high-frequency switching of a power switch. The device layout setting of the power conversion device and the winding mode of the transformer are provided, the size of the power conversion device is reduced, and the steady-state performance and the dynamic performance of the conversion device are improved.

The application discloses a power conversion device, comprising a half-bridge unit which comprising a first half-bridge unit and a second half-bridge unit, wherein each of the first half-bridge unit and the second half-bridge unit comprises at least two half-bridge switches, at least two half-bridge capacitors, at least two synchronous switches and a transformer; a transformer in the half-bridge unit forms a magnetic part; the magnetic part comprises a magnetic core, a primary side winding and a secondary side winding;

The power conversion device further comprises a circuit substrate, wherein the circuit substrate comprises a first surface and a second surface which are opposite to each other, a plurality of winding column holes and a middle column hole, and the winding column holes and the middle column hole penetrate through the first surface and the second surface; the magnetic core comprises a plurality of winding columns, a middle column and two magnetic substrates, the winding columns and the middle columns penetrate through the corresponding winding column holes and the corresponding middle column holes respectively, and the winding columns, the middle column and the two magnetic substrates are buckled with the circuit substrate; the magnetic core further comprises a first side edge and a third side edge opposite to each other, a second side edge and a fourth side edge opposite to each other, and a first diagonal line and a second diagonal line;

A synchronous switch in the first half-bridge unit is arranged adjacent to the first side edge, a synchronous switch in the second half-bridge unit is arranged adjacent to the third side edge, and a synchronous switch in the first half-bridge unit and a synchronous switch in the second half-bridge unit are both arranged close to the first diagonal line;
a half-bridge switch in the first half-bridge unit is arranged adjacent to a third side edge, a half-bridge switch in the second half-bridge unit is arranged adjacent to the first side edge, and a half-bridge switch in the first half-bridge unit and a half-bridge switch in the second half-bridge unit are both arranged adjacent to the second diagonal line.

Preferably, wherein a half-bridge capacitor in the first half-bridge unit is arranged adjacent to the third side edge, a half-bridge capacitor in the second half-bridge unit is arranged adjacent to the first side edge, and a half-bridge capacitor in the first half-bridge unit and a half-bridge capacitor in the second half-bridge unit are both arranged adjacent to the second diagonal line.

Preferably, a half-bridge capacitor and a half-bridge switch in the first half-bridge unit are respectively arranged on two opposite surfaces of the circuit substrate; and a half-bridge capacitor and a half-bridge switch in the second half-bridge unit are respectively arranged on two opposite surfaces of the circuit substrate.

Preferably, the numbers of synchronous switches included the first half-bridge unit and the second half-bridge unit are both two, the synchronous switch of the first half-bridge unit is arranged on the first surface, and the two synchronous switches of the second half-bridge unit are arranged on the second surface.

Preferably, wherein the projection on the first surface of the two synchronous switches arranged on the first surface is at least partially overlapped with the projection on the first surface of the corresponding two synchronous switches arranged the second surface.

Preferably, wherein each of the first half-bridge unit and the second half-bridge unit further comprises an output negative pin, the output negative pin in the first half-bridge unit is arranged adjacent to the first side edge, the output negative pin in the second half-bridge unit is arranged adjacent to the third side edge, and the output negative pin in the first half-bridge unit and the output negative pin in the second half-bridge unit are arranged adjacent to the first diagonal.

Preferably, wherein an output negative pin in the first half-bridge unit is arranged adjacent to a synchronous switch in the first half-bridge unit. Alternatively, an output negative pin in the second half-bridge unit is arranged adjacent to a synchronous switch in the second half-bridge unit. Alternatively, an output negative pin in the first half-bridge unit is arranged adjacent to a synchronous switch in the first half-bridge unit, and an output negative pin in the second half-bridge unit is arranged adjacent to a synchronous switch in the second half-bridge unit.

Preferably, wherein each of the first half-bridge unit and the second half-bridge unit further comprises an output positive pin, the output positive pin in the first half-bridge unit is arranged adjacent to the third side edge, the output positive pin in the second half-bridge unit is arranged adjacent to the first side edge, and the output positive pin in the first half-bridge unit and the output positive pin in the second half-bridge unit are arranged adjacent to the second diagonal line.

Preferably, wherein the magnetic part comprises four primary windings and four secondary windings, the magnetic core comprises four winding columns, the four primary windings are wound on the four winding columns respectively, and the four secondary windings are wound on the four winding columns respectively.

Preferably, wherein the magnetic core is buckled with the circuit substrate, and the four winding columns are arranged around the middle column, the four winding columns are respectively a first winding column, a second winding column, a third winding column and a fourth winding column, the first winding column is arranged adjacent to the first side edge and the second side edge, the second winding column is arranged adjacent to the second side edge and the third side edge, the third winding column is arranged adjacent to the first side edge and the fourth side edge, and the fourth winding column is arranged adjacent to the third side edge and the fourth side edge; and the four primary windings are respectively a first primary winding, a second primary winding, a third primary winding and a fourth primary winding; and the four secondary windings are respectively a first secondary winding, a second secondary winding, a third secondary winding and a fourth secondary winding; the second end of the first primary winding is electrically connected with the first end of the second primary winding, and the second end of the third primary winding is electrically connected with the first end of the fourth primary winding;
the second end of the first secondary winding is electrically connected with the first end of the second secondary winding, and the second end of the third secondary winding is electrically connected with the first end of the fourth secondary winding.

Preferably, a first channel is formed between the first winding column and the third winding column, a second channel is formed between the first winding column and the second winding column, a third channel is formed between the second winding column and the fourth winding column, and a fourth channel is formed between the fourth winding column and the third winding column; the first primary winding is electrically connected with the second primary winding in series, and the first primary winding and the second primary winding are wound on the first winding column and the second winding column in an 8-shaped manner; the third primary winding and the fourth primary winding are electrically connected in series, and the third primary winding and the fourth primary winding are wound on the third winding column and the fourth winding column in an 8-shaped manner; the first secondary winding is electrically connected with the second secondary winding, and is wound on the first winding column and the second winding column in an 8-shaped manner; and the third secondary winding is electrically connected with the fourth secondary winding, and is wound on the third winding column and the fourth winding column in an 8-shaped manner.

Preferably, wherein the power conversion device further comprises an output positive pin; the first end of the first primary winding and the second end of the second primary winding are arranged close to the third side edge, the first end of the first primary winding is electrically connected with the half-bridge switch in the same half-bridge unit, and the second end of the second primary winding is electrically connected with the half-bridge capacitor in the same half-bridge unit; the first end of the third primary winding and the second end of the fourth primary winding are arranged close to the first side edge, the first end of the third primary winding is electrically connected with the half-bridge switch in the same half-bridge unit, and the second end of the fourth primary winding is electrically connected with the half-bridge capacitor in the same half-bridge unit; the first end of the first secondary winding, the second end of the second secondary winding, the second end of the third secondary winding and the first end of the fourth secondary winding are arranged close to the first side edge, and the second end of the first secondary winding, the first end of the second secondary winding, the first end of the third secondary winding and the second end of the fourth secondary winding are arranged close to the third side edge; the first end of the first secondary winding, the second end of the second secondary winding, the first end of the third secondary winding and the second end of the fourth secondary winding are electrically connected to one of the synchronous switches, the second end of the first secondary winding, the first end of the second secondary winding, the second end of the third secondary winding and the first end of the fourth secondary winding are electrically connected to the output positive pin.

The application discloses a magnetic assembly, comprising a magnetic core, a primary winding, a first secondary winding and a second secondary winding; the magnetic core comprises a first side face and a third side face opposite to each other, a second side face and a fourth side face opposite to each other, a first winding column, a second winding column and a middle column; the first winding column is arranged adjacent to the first side face, the second winding column is arranged adjacent to the third side face, and the middle column is arranged adjacent to the fourth side face;
and the first end and the second end of the primary winding are arranged close to the third side
the primary winding is wound around the first winding column and the second winding column from the first end to the second end, and the winding direction of the primary winding from the first end to the second end on the first winding column is opposite to the winding direction on the second winding column; a second end of the first secondary winding and a first end of the second secondary winding are short-circuited at a node, which is arranged adjacent to the third side; the first end of the first secondary winding and the second end of the second secondary winding are arranged adjacent to the first side; and the secondary winding is wound around the first winding column and the second winding column from the first end to the second end of the second secondary winding.

Preferably, wherein the first end of the primary winding is arranged between the second winding column and the fourth side, and the second end of the primary winding is arranged between the second winding column and the second side.

Preferably, the first end of the first secondary winding is arranged between the first winding column and the second side face, and the second end of the second secondary winding is arranged between the first winding column and the fourth side face.

Preferably, wherein a first end of the primary winding is electrically connected to two switching elements.

Preferably, wherein the second end of the primary winding is electrically connected to two capacitor elements.

Preferably, wherein the first end of the first secondary winding and the second end of the second secondary winding are both electrically connected to a switching element.

Preferably, wherein short contacts of the first secondary winding and the second secondary winding are electrically connected to a capacitor element.

Compared with the prior art, the application has the following beneficial effects:
(1) the circuit topology of the invention is suitable for the application of the input voltage to the high step-down ratio of the output voltage; and the circuit topology has low switching loss and high conversion efficiency in the occasion of high-frequency switching of the power switch; the input ends of the two half-bridge units are connected in series and the output ends of the two half-bridge units are connected in parallel and the input voltage of each half-bridge unit is reduced, so that the switching loss of the power switch device in each half-bridge unit is reduced, and the conversion efficiency of each half-bridge unit and the whole power conversion circuit is improved
(2) According to the device layout setting of the power conversion device and the winding mode of the transformer, the size of the power conversion device is reduced, and the steady-state performance and the dynamic performance of the conversion device are improved; according to the winding method of the transformer winding, the power conversion device can output current from two opposite side edges of the magnetic core, the wiring area of the power current is increased, the parasitic resistance on the power current path is reduced, and the method is particularly suitable for occasions where the input voltage is high in voltage reduction ratio and output to low-voltage large current.

### BRIEF DESCRIPTION OF THE DRAWINGS

FIG. 1 is a schematic diagram of a circuit topology.

FIG. 2 is a three-dimensional structure diagram of a power conversion device.

FIG. 3A and FIG. 3B are cross-sectional views of a transformer winding.

FIG. 4A and FIG. 4B are schematic layout diagrams of a power conversion device.

FIG. 5 is a schematic diagram of driving power supply.

FIG. 6 is a schematic diagram of a circuit topology.

FIG. 7A is a schematic diagram of a circuit topology.

FIG. 7B and FIG. 7C are cross-sectional views of another transformer winding.

### DESCRIPTION OF THE EMBODIMENTS

The present application discloses various embodiments or examples of implementing the thematic technological schemes mentioned. To simplify the disclosure, specific instances of each element and arrangement are described below. However, these are merely examples and do not limit the scope of protection of this application. For instance, a first feature recorded subsequently in the specification formed above or on top of a second feature may include an embodiment where the first and second features are formed through direct contact, or it may include an embodiment where additional features are formed between the first and second features, allowing the first and second features not to be directly connected. Additionally, these disclosures may repeat reference numerals and/or letters in different examples. This repetition is for brevity and clarity and does not imply a relationship between the discussed embodiments and/or structures. Furthermore, when a first element is described as being connected or combined with a second element, this includes embodiments where the first and second elements are directly connected or combined with each other, as well as embodiments where one or more intervening elements are introduced to indirectly connect or combine the first and second elements.

One of the cores of the invention is to provide a circuit topology which is suitable for the application of the input voltage to the high-voltage-reduction ratio of the output voltage. The circuit topology has low switching loss and high conversion efficiency in the occasion of high switching frequency. Another core of the present invention is to provide a power conversion device. The device layout setting of the power conversion device and the winding mode of the transformer are provided, the size of the power conversion device is reduced, and the steady-state performance and the dynamic performance of the conversion device are improved.

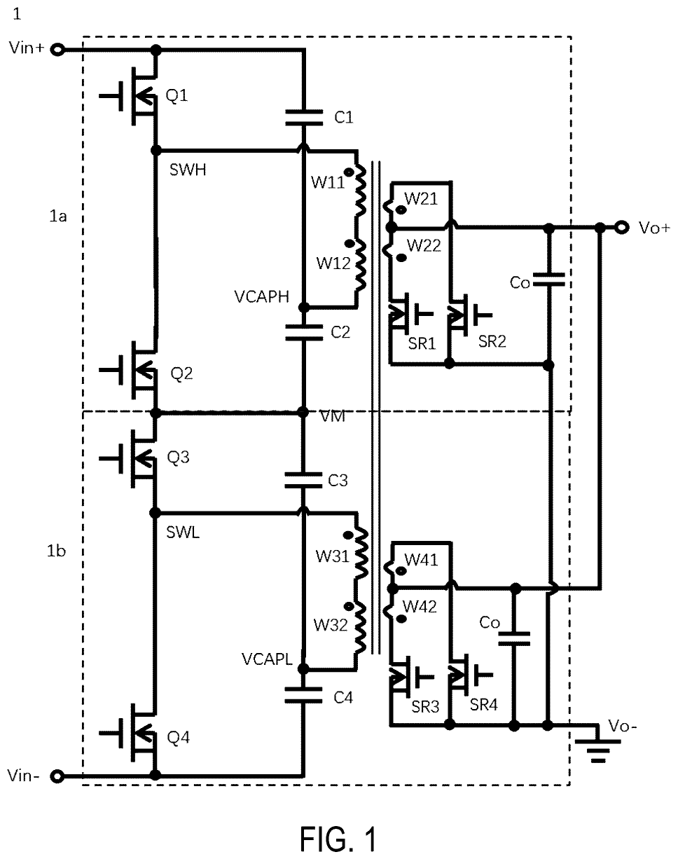

The input ends of the two half-bridge circuits are connected in series, and the output ends of the two half-bridge circuits are connected in parallel, as shown in the circuit diagram shown in FIG. 1; the circuit topology 1 comprises two half-bridge units 1a and 1b; the input ends of the two half-bridge units 1a and 1b are connected in series; and the output ends of the two half-bridge units 1a and 1b are connected in parallel. Wherein the half-bridge unit 1a comprises two half-bridge switches Q1 and Q2, two half-bridge capacitors C1 and C2, a transformer, two synchronous switches SR1 and SR2 and an output capacitor Co; wherein the source electrode of the half-bridge switch Q1 and the drain electrode of the Q2 are electrically connected to the series midpoint SWH, and the second end of the half-bridge capacitor C1 and the first end of the C2 are electrically connected to the series midpoint VCAPH; the drain electrode of the half-bridge switch Q1 and the first end of the half-bridge capacitor C1 are electrically connected to the input positive end Vin+; and the source electrode of the half-bridge switch Q2 and the second end of the half-bridge capacitor C2 are electrically connected to the series point VM. The transformer comprises two primary windings W11 and W12, two secondary windings W21 and a W22. The second ends of the primary windings W11 are electrically connected with the first end of the primary winding W12, the first end of the primary winding W11 is electrically connected with the series midpoint SWH, and the second end of the primary winding W12 is electrically connected with the series midpoint VCAPH; and the second end of the secondary winding W21 and the first end of the W22 are electrically connected to the output positive end Vo+; the first end of the secondary winding W21 is electrically connected with the drain electrode of the synchronous switch SR2; and the second end of the secondary side winding W22 is electrically connected with the drain electrode of the synchronous switch SR1. The primary winding W11 and the secondary winding W21 are wound on the same winding column, and the first end of the primary winding W11 and the second end of the secondary winding W21 are dotted terminals and are labeled as point ends; the primary winding W12 and the secondary winding W22 are wound on the same winding column, and the first end of the primary winding W21 and the second end of the secondary winding W22 are dotted terminals and are labeled as point ends. The source electrodes of the two synchronous switches SR1 and SR2 are electrically connected to the output negative end Vo−. The output capacitor Co is bridged between the output positive end Vo+ and the output negative end Vo−. The half-bridge unit 1b comprises two half-bridge switches Q3 and Q4, two half-bridge capacitors C3 and C4, a transformer, two synchronous switches SR3 and SR4 and an output capacitor Co; the structure of the bridge unit 1b is basically the same as the structure of 1a, and the difference lies in that the source electrode of the half-bridge switch Q3 and the drain electrode of Q4 are electrically connected to the series midpoint SWL, and the second end of the half-bridge capacitor C3 and the first end of C4 are electrically connected to the series midpoint VCAPL, the drain electrode of the half-bridge switch Q3 and the first end of the half-bridge capacitor C3 are electrically connected to the series point VM, and the source electrode of the half-bridge switch Q4 and the second end of the half-bridge capacitor C4 are electrically connected to the input negative end Vin−. The transformer comprises primary windings W31/W32 and secondary windings W41/W42, and the connection mode and the dotted terminals are similar to the transformer connection mode in the half-bridge unit 1a; specifically, the second end of the primary winding W31 is electrically connected with the first end of the W32, the first end of the primary winding W31 is electrically connected with the series midpoint SWL, and the second end of the primary winding W32 is electrically connected with the series midpoint VCAPL; and the second end of the secondary winding W41 and the first end of the W42 are electrically connected to the output positive end Vo+; the first end of the secondary winding W41 is electrically connected with the drain electrode of the synchronous switch SR4; and the second end of the secondary side winding W22 is electrically connected with the drain electrode of the synchronous switch SR3. The primary winding W31 and the secondary winding W41 are wound on the same winding column, and the first end of the primary winding W31 and the second end of the secondary winding W41 are dotted terminals and are labeled as point ends; the primary winding W32 and the secondary winding W42 are wound on the same winding column, and the first end of the primary winding W32 and the second end of the secondary winding W42 are dotted terminals and are labeled as point ends; the source electrodes of the two synchronous switches SR3 and SR4 are electrically connected to the output negative end Vo−. The output capacitor Co is bridged between the output positive end Vo+ and the output negative end Vo−. Furthermore, the primary winding W11, the primary winding W12, the primary winding W31 and the primary winding W32 are respectively wound on four different winding columns.

According to the invention, the input voltage of each half-bridge unit is reduced by connecting the input ends of the two half-bridge units in series and the output end of each half-bridge unit in parallel, so that the switching loss of the power switch device in each half-bridge unit is reduced, and the conversion efficiency of each half-bridge unit and the whole power conversion circuit is improved. In the half-bridge units 1a and 1b, the switching frequencies of the PWM driving signals of the corresponding half-bridge switches are the same, and the duty ratios are the same, the phase-shift is 90 degrees; and the switching frequencies of the PWM driving signals of the upper switch and the lower switch of each half-bridge unit are the same, and the duty ratios are the same, the phase-shift is 180 degrees so that PWM driving signals of the half-bridge switch Q1, the half-bridge switch Q2, the half-bridge switch Q3 and the half-bridge switch Q4 are sequentially staggered by 90 degrees; so that the frequency of the pulse current of the input end is four times switching frequency of each half-bridge switch, and the size of the input filter can be greatly reduced. In addition, the PWM driving signal of the synchronous switch SR1 is complementary to the PWM driving signal of the half-bridge switch Q1; the PWM driving signal of the synchronous switch SR2 is complementary to the PWM driving signal of the half-bridge switch Q2; the PWM driving signal of the synchronous switch SR3 is complementary to the PWM driving signal of the half-bridge switch Q3; and the PWM driving signal of the synchronous switch SR4 is complementary to the PWM driving signal of the half-bridge switch Q4.

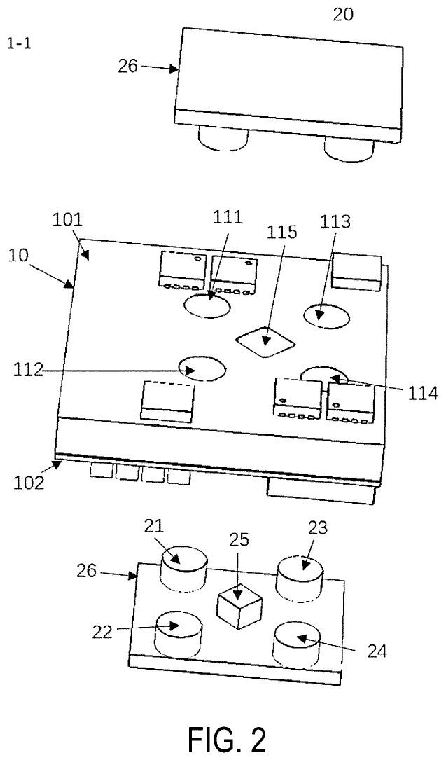

The invention further discloses a power conversion device 1-1, which is applied to the circuit schematic diagram shown in FIG. 1. The three-dimensional structure diagram of the power conversion device 1-1 is shown in FIG. 2, and comprises a circuit substrate 10, a magnetic core 20, a plurality of switches and a plurality of capacitors. The magnetic core 20 comprises two magnetic substrates 26, a first winding column 21, a second winding column 22, a third winding column 23, a fourth winding column 24 and a middle column 25.

The circuit substrate 10 comprises a first surface 101, a second surface 102, a first hole 111, a second hole 112, a third hole 113, a fourth hole 114 and a middle column hole 115, wherein the first surface 101 and the second surface 102 are opposite; the first hole 111, the second hole 112, the third hole 113, the fourth hole 114 and the middle column hole 115 penetrate through the first surface 101 and the second surface 102 respectively and are used for enabling the first winding column 21, the second winding column 22, the third winding column 23, the fourth winding column 24 and the middle column 25 to penetrate through, the two magnetic substrates 26 are respectively attached to the first surface 101 and the second surface 102, and after the magnetic core 20 is buckled with the circuit substrate 10, the magnetic core 20 and a winding arranged in the circuit substrate form a circuit diagram as shown in FIG. 1. In the embodiment, the first hole 111, the second hole 112, the third hole 113 and the fourth hole 114 are respectively arranged around the middle column hole, and after the magnetic core 20 is buckled with the circuit substrate, the middle column 25 is surrounded by the first winding column 21, the second winding column 22, the third winding column 23 and the fourth winding column 24. The plurality of switches and the plurality of capacitors are respectively disposed on the first surface 101 and the second surface 102.

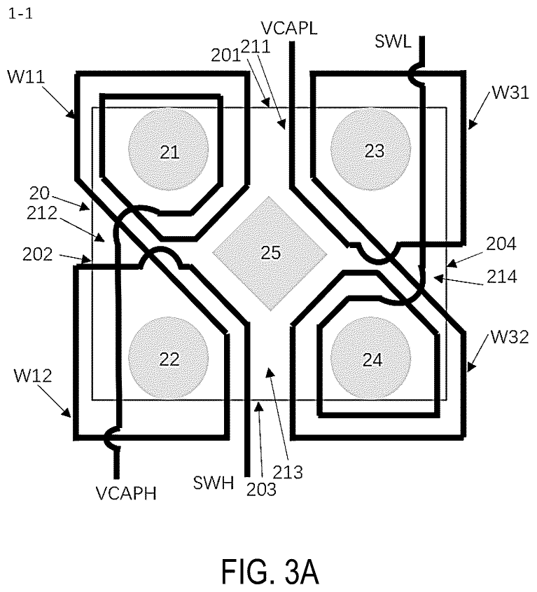

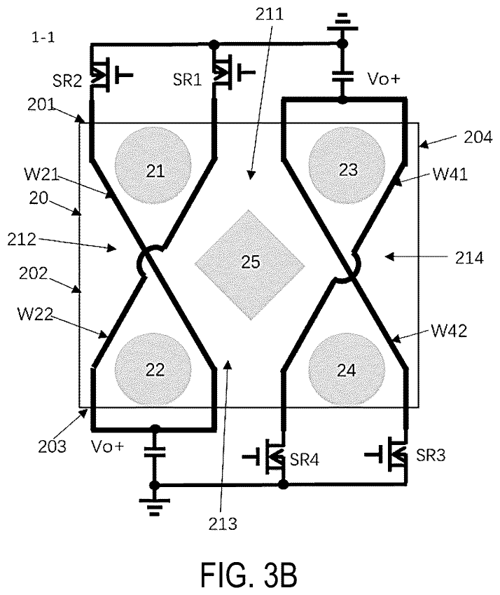

The invention further discloses a winding method of the transformer adopted by the power conversion device 1-1. As shown in the sectional view shown in FIGS. 3A and 3B, FIG. 3A is a winding method of the primary windings W11, W12, W31 and W32, and the winding method of the secondary windings W21, W22, W41 and W42 is shown in FIG. 3B. As shown in FIG. 3A, the magnetic core 20 comprises a first side edge 201 and a third side edge 203 opposite to each other, the second side edge 202 and the fourth side edge 204 opposite to each other. A first channel 211 is formed between the first winding column 21 and the third winding column 23, and the first channel 211 is adjacent to the first side edge 201; a second channel 212 is formed between the first winding column 21 and the second winding column 22, and the second channel 212 is adjacent to the second side edge 202; a third channel 213 is arranged between the second winding column 22 and the fourth winding column 24, and the third channel 213 is adjacent to the third side edge 203; a fourth channel 214 is arranged between the fourth winding column 24 and the third winding column 23, and the fourth channel 214 is adjacent to the fourth side edge 204.

As shown in FIG. 3A, after the primary windings W11 and W12 are electrically connected in series, the primary windings W11 and W12 are wound on the first winding column 21 and the second winding column 22 in the shape of “8”; and after the primary windings W31 and W32 are electrically connected in series, the primary windings W31 and W32 are wound on the third winding column 23 and the fourth winding column 24 in the shape of “8”. Specifically, a first end (the series midpoint SWH) of the primary winding W11 and a second end (the series midpoint VCAPH) of the primary winding W12 are arranged adjacent to a third side edge 203 of the magnetic core 20. From the SWH to the VCAPH, the primary winding penetrates through the third channel 213, winding at least one circle around the second winding column 22 in a counterclockwise direction (equivalent to a first direction), then passing through the second channel 212 and the first channel 211, winding at least one circle around the first winding column 21 in a clockwise direction (equivalent to a second direction), and returning to the third side edge 203. The first end (the SWL) of the primary winding W31 and the second end (the VCAPL) of the primary winding W32 are arranged close to the first side edge 201 of the magnetic core 20. From the SWL to the VCAPL, and the primary side winding firstly goes along the fourth side edge and then passes through the fourth channel 214, at least one circle is wound counterclockwise around the fourth winding column 24, and then passes through the fourth channel 214 and the first channel 211, and at least one circle is wound clockwise around the third winding column 23 and returns to the first side edge 201. According to the embodiment, the primary winding is wound two circles on each winding column 2 as an example for description, and is not limited this, in some other embodiments, the primary winding can also respectively wind one or more circles on each winding column, and a person skilled in the art can select the corresponding number of turns according to actual requirements.

As shown in FIG. 3B, after the secondary winding W21 and the secondary winding W22 are electrically connected in series, the secondary winding W21 and the secondary winding W22 are wound on the first winding column 21 and the second winding column 22 in a shape of “8”; and after the secondary winding W41 and the secondary winding W42 are electrically connected in series, the secondary winding W41 and the secondary winding W42 are wound on the third winding column 23 and the fourth winding column 24 in an “8” shape. Specifically, the first end of the secondary winding W21 and the second end of the W22 are arranged adjacent to the first side edge 201 of the magnetic core 20; and the second end of the secondary winding W21 and the first end of the W22 are short-circuited (ie the output positive end Vo+) is arranged adjacent to the third side edge 203 of the magnetic core 20. From the first end to the second end of the secondary winding W21, the secondary winding W21 is wound along the second side edge, and then passes through the second channel 212 and passes through the third through channel 213; From the first end to the of the secondary winding W22, the secondary winding W22 is wound along the second side edge, then passes through the second channel 212, passes through the first channel 211. The first end of the secondary side winding W41 and the second end of the W42 are arranged adjacent to the third side edge 203 of the magnetic core 20; and the second end of the secondary side winding W41 and the first end of the W41 are short-circuited (ie the output positive end Vo+) and are arranged adjacent to the first side edge 201 of the magnetic core 20. From the first end to the second end of the secondary winding W41, the secondary winding W41 passes through the third channel 213 and then passes through the fourth channel 214, and then goes along the fourth side edge 204. From the first end to the second end of the secondary winding W42, the secondary winding W42 passes through the first channel 211, passes through the fourth channel 214, and goes along the fourth side 204. In this embodiment, the magnetic piece comprises the magnetic core 20, the four primary windings W11/W12/W31/W32 and the four secondary windings W21/W22/W41/W42.

In the invention, the connecting end of the secondary winding of the first half-bridge unit 1a and the synchronous switch, the connecting end of the secondary winding and the synchronous switch of the second half-bridge unit 1b are respectively arranged close to the first side edge 201 and the third side edge 203 of the magnetic core 20, and are respectively adjacent to the first winding column 21 and the fourth winding column 24; so that the connecting end of the secondary winding of the first half-bridge unit 1a and the synchronous switch and the connecting end of the secondary winding and the synchronous switch of the second half-bridge unit 1b are arranged adjacent to the first diagonal of the magnetic core 20 (the first diagonal passes through the first winding column 21, the middle column 25 and the fourth winding column 24). The connecting end of the primary winding and the half-bridge switch of the first half-bridge unit 1a and the connecting end of the primary winding and the half-bridge switch of the second half-bridge unit 1b are respectively arranged close to the third side edge 203 and the first side edge 201 of the magnetic core 20, and are respectively adjacent to the second winding column 22 and the third winding column 23; so that the connecting end of the primary winding and the half-bridge switch of the first half-bridge unit 1a and the connecting end of the primary winding and the half-bridge switch of the second half-bridge unit 1b are arranged adjacent to the second diagonal of the magnetic core 20 (the second diagonal penetrates through the second winding column 22, the middle column 25 and the third winding column 23). A first diagonal and a second diagonal of the magnetic core 20 intersect perpendicularly. According to the winding method of the transformer winding, the power conversion device can output current from two opposite side edges of the magnetic core, the wiring area of the power current is increased, the parasitic resistance on the power current path is reduced, and the transformer winding is particularly suitable for applications with the high ratio of the input voltage to the output voltage and large current.

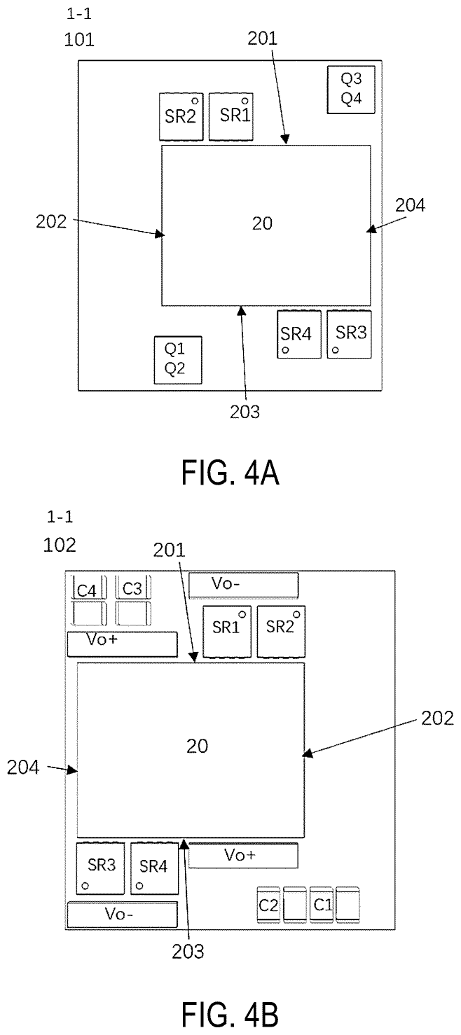

In combination with the schematic diagram of the device layout on the first surface 101 shown in FIG. 4A, the synchronous switches SR1 and SR2 are arranged adjacent to the first side edge 201 of the magnetic core 20, that is, the synchronous switches SR1 and SR2 are respectively arranged adjacent to the second end of the secondary winding W22 and the first end of W21, so that the loop path enclosed by the synchronous switch SR1, the secondary winding W22, the secondary winding W21 and the synchronous switch SR2 is the shortest, the parasitic parameters on the loop are reduced, and the conversion efficiency of the power conversion device is improved. Similarly, the synchronous switches SR3 and SR4 are arranged adjacent to the third side edge 203 of the magnetic core 20, that is, the synchronous switches SR3 and SR4 are respectively arranged adjacent to the second end of the secondary winding W42 and the first end of the secondary winding W41, so that the loop path of the synchronous switch SR3, the secondary winding W42, the secondary winding W41 and the synchronous switch SR4 is the shortest, the parasitic parameters on the loop are reduced, and the conversion efficiency of the power conversion device is improved. The synchronous switch of the first half-bridge unit and the synchronous switch of the second half-bridge unit are respectively arranged on the first side edge 201 and the third side edge 203 of the magnetic core 20 and are respectively adjacent to the first winding column 21 and the fourth winding column 24; the synchronous switch of the first half-bridge unit and the synchronous switch of the second half-bridge unit are arranged close to the first diagonal of the magnetic core 20.

Referring to FIG. 3A and FIG. 4A, half-bridge switches Q1 and Q2 are disposed adjacent to a third side edge 203 of the magnetic core 20, that is, half-bridge switches Q1 and Q2 are disposed adjacent to a first end of the primary winding W11; half-bridge switches Q3 and Q4 are disposed adjacent to a first side edge 201 of the magnetic core 20, that is, half-bridge switches Q3 and Q4 are disposed adjacent to a first end of the primary winding W31. The half-bridge switch of the first half-bridge unit and the half-bridge switch of the second half-bridge unit are respectively arranged adjacent to the third side edge 203 and the first side edge 201 of the magnetic core 20, and are respectively adjacent to the second winding column 22 and the third winding column 23; and the half-bridge switch of the first half-bridge unit and the half-bridge switch of the second half-bridge unit are arranged adjacent to the second diagonal of the magnetic core 20.

With reference to the schematic diagram of the device layout on the second surface 102 shown in FIG. 4B, the half-bridge capacitors C1, C2, C3 and C4 of the first half-bridge unit and the second half-bridge unit output positive pins Vo+ and output negative pins Vo−. The synchronous switches SR1 and SR2 of the first half-bridge unit arranged on the second surface 102 are respectively connected in parallel with the synchronous switches SR1 and SR2 of the first half-bridge unit on the first surface 101; and the projections of the synchronous switches SR1 arranged on the first surface 101 and the second surface 102 at least partially overlapped on the first surface 101, and the projections of the synchronous switches SR2 arranged on the first surface 101 and the second surface 102 at least partially overlapped on the first surface 101. Similarly, the synchronous switches SR3 and SR4 of the second half-bridge unit on the second surface 102 are respectively connected in parallel with the synchronous switches SR3 and SR4 of the second half-bridge unit on the first surface 101; and the projections of the synchronous switches SR3 arranged on the first surface 101 and the second surface 102 are at least partially overlapped on the first surface 101, and the projections of the synchronous switches SR4 arranged on the first surface 101 and the second surface 102 at least partially overlapped on the first surface 101. The half-bridge capacitors C1 and C2 are arranged adjacent to the third side edge 203 of the magnetic core 20, and the positions of the half-bridge capacitors C1 and C2 are adjacent to the projection of the half-bridge switches Q1 and Q2 on the horizontal plane, so that the loop area formed by the half-bridge switch, the primary winding and the half-bridge capacitor is reduced, the parasitic parameters of the loop are further reduced, and the conversion efficiency is improved. The half-bridge capacitors C3 and C4 are arranged adjacent to the first side edge 201 of the magnetic core 20, and the positions of the half-bridge capacitors C3 and C4 are adjacent to the projection of the half-bridge switches Q3 and Q4 on the horizontal plane, so that a loop formed by the half-bridge switch, the primary winding and the half-bridge capacitor is reduced. The two output positive pins Vo+ are respectively adjacent to the first side edge 201 and the third side edge 203 of the magnetic core 20, and are respectively adjacent to the second winding column 22 and the third winding column 23, that is, respectively disposed adjacent to the second diagonal of the magnetic core 20.

The two output negative pins Vo− are respectively arranged on two opposite sides of the magnetic core 20 and are arranged adjacent to the first diagonal; furthermore, the two output negative pins Vo− are respectively arranged on the outer sides of the first half-bridge unit synchronous switch and the second half-bridge unit synchronous switch, and are respectively adjacent to the source electrodes of the corresponding synchronous switches. The two output positive pins Vo+ are arranged on the two opposite sides of the magnetic core 20 and are arranged adjacent to the second diagonal.

The synchronous switch of the first half-bridge unit and the synchronous switch of the second half-bridge unit are respectively arranged on the first side edge 201 and the third side edge 203 of the magnetic core 20 and are arranged adjacent to the first diagonal; and the output positive pins are respectively arranged on the first side edge 201 and the third side edge 203 of the magnetic core 20 and are arranged adjacent to the second diagonal, so that the power conversion device can output current from the two side edges of the magnetic core, the wiring area of the power current is increased, the parasitic resistance on the power current path is reduced, and the power conversion device is particularly suitable for applications with the high ratio of the input voltage to the output voltage and large current. Because the output positive pin Vo+ is adjacent to the second winding column 22 and the third winding column 23 respectively, and the output negative pins Vo− is adjacent to the source of the synchronous switch, the wiring distance of the output positive pin Vo+ or the output negative pin Vo− is the shortest, and the parasitic resistance is minimum.

According to the winding method disclosed by the invention, the direct-current magnetic flux flowing through each winding column is added on the middle column, and the alternating-current magnetic flux flowing through each winding column is superposed on the middle column according to the phase; and the two half-bridge units 1a and 1b are controlled in a staggered mode, so that the voltage waveforms of the windings on the four winding columns are staggered by 90 degrees respectively, that is, the alternating-current magnetic flux waveforms of the four winding columns are staggered by 90 degrees respectively, so that the circuit topology obtains the advantages of small output dynamic inductance and large output steady-state inductance. The volume of the magnetic core can be reduced, and the steady-state characteristic and the dynamic transformation characteristic of the power conversion device are improved.

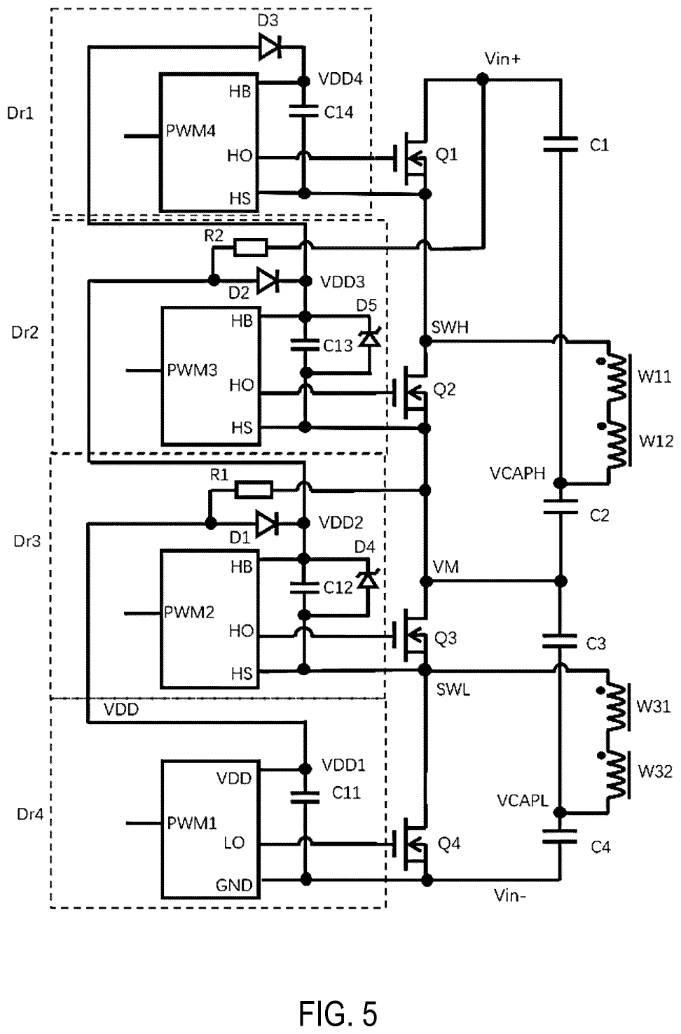

The invention further discloses a driving power supply mode after the half-bridge units are connected in series. As shown in FIG. 5, the power conversion device further comprises four driving units DR1, DR2, DR3 and DR4 which provide driving signals for the half-bridge switches Q1, Q2, Q3 and Q4 respectively; and the four driving units each comprise a driver and a driving capacitor (driving capacitors CL1, CL2, CL3 and CL4 in the figure). The driving units DR1, DR2 and DR3 each further comprise a driving diode (driving diodes D1, D2 and D3 in the figure), and the driving units DR2 and DR3 each further comprise a driving resistor and a voltage stabilizing diode (driving resistors R1 and R2 in the figure, voltage stabilizing diodes D4 and D5). The power supply voltage of the driving unit DR4 is VDD, that is, the voltage of the driving capacitor CL1 between the electric network VDD1 and the input negative end Vin− is the power supply voltage VDD. In the driving unit DR3, the positive electrode of the driving diode D1 is electrically connected with the electric network VDD1, and the negative electrode of the driving diode D1 is electrically connected with the electric network VDD2; one end of the driving resistor R1 is electrically connected with the electric network VDD1, and the other end of the driving resistor R1 is electrically connected with the series point VM; and after the voltage stabilizing diode D4 and the driving capacitor CL2 are connected in parallel, the voltage stabilizing diode D4 is bridged between the electric network VDD2 and the series midpoint SWL. when the half-bridge switch Q4 is switched on, the series midpoint SWL is short-circuited to the input negative end VIN−, the driving capacitor C11 is connected in parallel with the driving capacitor C12 through the driving diode D1, the voltage at the two ends of the driving capacitor C12 is equal to the power supply voltage VDD (ignoring the conduction voltage drop of the driving diode D1), and the driving capacitor C12 provides power for the driving unit DR3. In the driving unit DR2, the positive electrode of the driving diode D2 is electrically connected with the electric network VDD2, and the negative electrode of the driving diode D2 is electrically connected with the electric network VDD3; one end of the power supply resistor R2 is electrically connected with the electric network VDD2, and the other end of the driving resistor R2 is electrically connected with the input positive end Vin+; and after the voltage stabilizing diode D5 and the driving capacitor CL3 are connected in parallel, the voltage stabilizing diode D5 is bridged between the electric network VDD3 and the series point VM. When the half-bridge switch Q3 is switched on, the series point VM is short-circuited with the series midpoint SWL, the driving capacitor C12 is connected in parallel with the driving capacitor C13 through the driving diode D2, the voltage at the two ends of the driving capacitor C13 is equal to the driving voltage VDD (ignoring the conduction voltage drop of the driving diode D2), and the driving capacitor C13 provides power for the driving unit DR2. In the driving unit DR1, the positive electrode of the driving diode D3 is electrically connected with the electric network VDD3, the negative electrode of the driving diode D3 is electrically connected with the electric network VDD4, and the driving capacitor CL4 is bridged between the electric network VDD4 and the series midpoint SWH. When the half-bridge switch Q2 is switched on, the series midpoint SWH is short-circuited with the series point VM, the driving capacitor C13 is connected in parallel with the driving capacitor C14 through the driving diode D3, the voltage at the two ends of the driving capacitor C14 is equal to the power supply voltage VDD (ignoring the conduction voltage drop of the driving diode D3), and the driving capacitor C14 provides power for the driving unit DR1. At the moment when the power conversion device is started, the voltage VDD 3 at the two ends of the driving capacitor CL3 is not established, and at the moment, the input positive end Vin+ realizes pre-charging for the driving capacitor C13 through the driving resistor R2; and when the power conversion device is started, the driving units DR1 and DR2 can output normal PWM signals. Similarly, the driving resistor R1 and the driving resistor R2 have similar functions; and the voltage (equivalent to Vin 2) of the series point VM realizes pre-charging for the driving capacitor C12 through the driving resistor R1, so that the power conversion device is started instantly, and the pre-charging energy of the driving capacitor C12 can be supplied to the driving capacitor CL3. The driving power supply circuit disclosed by the invention can realize driving power supply of four half-bridge switches connected in series, and the circuit is simple and easy to implement.

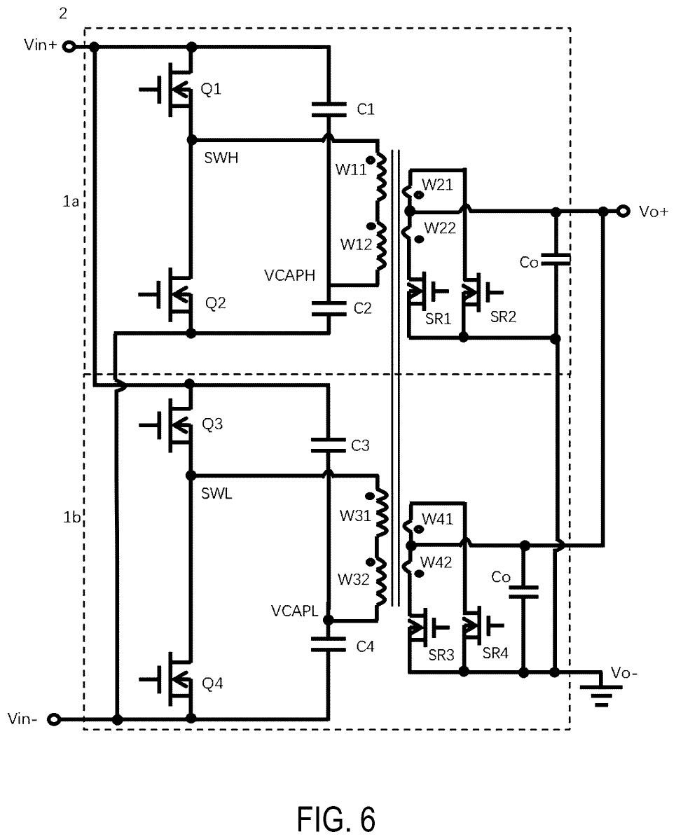

The device layout and the winding mode of the transformer are also suitable for the circuit topology 2 shown in FIG. 6, the circuit topology 2 also comprises two half-bridge units 1a and 1b, and the two half-bridge units 1a and 1b are different from the circuit topology 1 in that the input ends of the two half-bridge units 1a and 1b are connected in parallel, and the output ends are also connected in parallel. The power conversion device adopting the circuit topology 2 can adopt the same transformer winding method and device layout mode as shown in FIG. 2, FIG. 3A, FIG. 3B, FIG. 4A and FIG. 4B, and the same benefits can also be obtained.

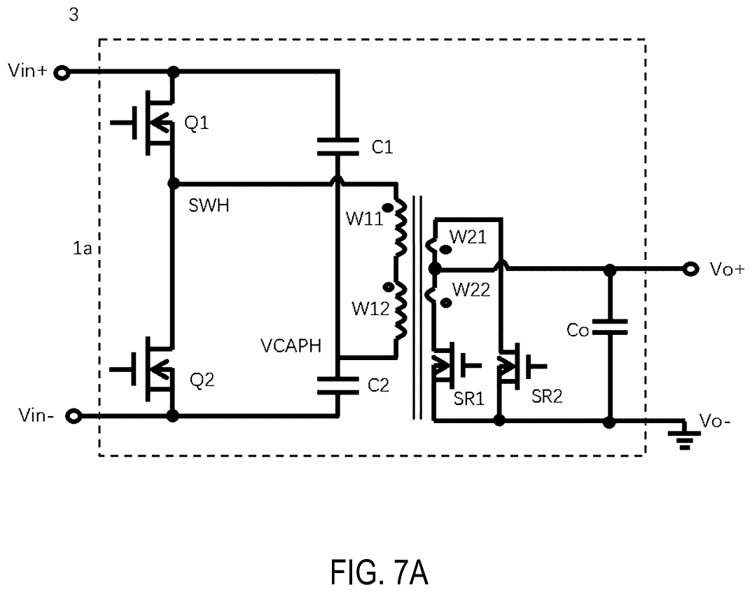

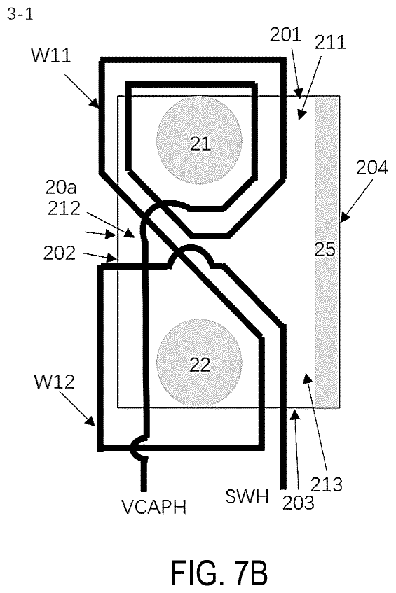

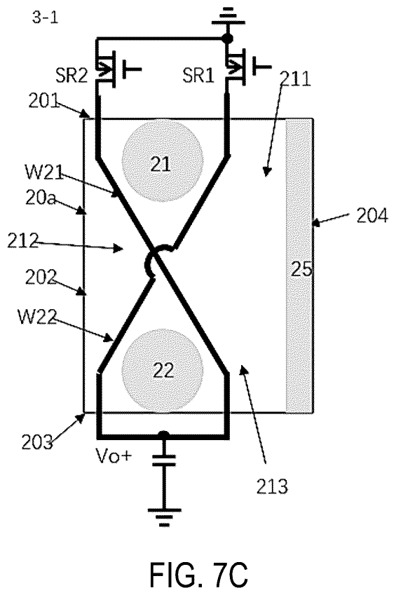

In some other embodiments, the circuit topology 3 shown in FIG. 7A can also be applied, the circuit topology 3 only comprises a magnetic core adopted by the power conversion device 3-1 corresponding to one half-bridge unit 1a as shown in FIG. 7B, the magnetic core 20A comprises a first winding column 21, a second winding column 22 and a middle column 25, and the circuit topology further comprises a first side edge 201, a second side edge 202, a third side edge 203 and a fourth side edge 204; the first side edge 201 and the third side edge 203 are opposite, and the second side edge 202 and the fourth side edge 204 are opposite; the middle column 25 is arranged adjacent to the fourth side edge 204, a first channel 211 is formed between the middle column 25 and the first winding column 21, and the first channel 211 is adjacent to the first side edge 201; a second channel 212 is formed between the first winding column 21 and the second winding column 22, and the second channel 212 is adjacent to the second side edge 202; a third winding channel 213 is arranged between the second winding column 22 and the middle column 25, the third winding channel 213 is adjacent to the third side 203, and the winding mode of the secondary windings W21 and W22 can be referred to FIG. 7B and FIG. 7C, and the winding mode is similar to the winding mode shown in FIG. 3A and FIG. 3B. The half-bridge switches Q1 and Q2, the synchronous switches SR1 and SR2, the half-bridge capacitors C1 and C2, and the layout of the output positive pin Vo+ and the output negative pin Vo− are similar to those shown in FIGS. 4A and 4B, and the features and advantages of the embodiments can be obtained, and details are not described herein again.

According to the transformer magnetic core or the magnetic column (the middle column) in the inductor magnetic core, the magnetic columns (side columns and the middle column) in the transformer magnetic core or the inductor magnetic core can be independently formed, the magnetic columns can be integrally formed with one magnetic substrate, or each magnetic column is divided into two parts, and each part is integrally formed with one magnetic substrate; and the transformer magnetic core material and the inductor magnetic core material can be made of ferrite. The cross section of the magnetic column connected to the magnetic substrate of the transformer magnetic core or the inductor magnetic core and the cross section of the magnetic substrate may be rectangular, square, circular, oval, etc., and are not limited thereto.

The switch disclosed by the invention can be a Si MOSFET, SiC MOSFET, GaN MOSFET or IGBT MOSFET and etc., and the function of the switch disclosed by the invention can be realized.

The power conversion device can be part of the electronic device or an independent power supply module as long as the technical features and advantages disclosed by the invention can be satisfied.

The “equal” or “same” or “equal to” disclosed by the application needs to consider the parameter distribution of engineering, and the error distribution is within +/−30%; the two line segments or the two straight lines are defined as the two line segments or the included angle between the two line segments or the two straight lines is less than or equal to 45 degrees; the included angle between the two line segments or the two straight lines is within the range of [60, 120]; and the definition of the phase error phase also needs to consider the parameter distribution of the project, and the error distribution of the phase error degree is within +/−30%.

Those skilled in the art can easily understand that the above are only preferred embodiments of the present disclosure, and are not intended to limit the present disclosure. Any modifications, equivalent replacements and improvements made within the spirit and principles of the present disclosure, etc., should be included within the protection scope of the present disclosure.

What is claimed is:

1. A power conversion device, comprising: a half-bridge unit which comprising a first half-bridge unit and a second half-bridge unit, wherein each of the first half-bridge unit and the second half-bridge unit comprises at least two half-bridge switches, at least two half-bridge capacitors, at least two synchronous switches and a transformer, wherein a transformer in the half-bridge unit forms a magnetic part, wherein the magnetic part comprises a magnetic core, a primary side winding and a secondary side winding,
wherein the power conversion device further comprises a circuit substrate, wherein the circuit substrate comprises a first surface and a second surface which are opposite to each other, a plurality of winding column holes and a middle column hole, wherein the plurality of winding column holes and the middle column hole penetrate through the first surface and the second surface, wherein the magnetic core comprises a plurality of winding columns, a middle column and two magnetic substrates, the plurality of winding columns and the middle column penetrate through the corresponding plurality of winding column holes and the middle column hole respectively, wherein the plurality of winding columns, the middle column and the two magnetic substrates are buckled with the circuit substrate, wherein the magnetic core further comprises a first side edge and a third side edge opposite to each other, a second side edge and a fourth side edge opposite to each other, a first diagonal line and a second diagonal line,
wherein a synchronous switch in the first half-bridge unit is arranged adjacent to the first side edge, a synchronous switch in the second half-bridge unit is arranged adjacent to the third side edge, and a synchronous switch in the first half-bridge unit and a synchronous switch in the second half-bridge unit are both arranged close to the first diagonal line,
wherein a half-bridge switch in the first half-bridge unit is arranged adjacent to a third side edge, a half-bridge switch in the second half-bridge unit is arranged adjacent to the first side edge, and a half-bridge switch in the first half-bridge unit and a half-bridge switch in the second half-bridge unit are both arranged adjacent to the second diagonal line.

2. The power conversion device of claim 1, wherein a half-bridge capacitor in the first half-bridge unit is arranged adjacent to the third side edge, a half-bridge capacitor in the second half-bridge unit is arranged adjacent to the first side edge, and a half-bridge capacitor in the first half-bridge unit and a half-bridge capacitor in the second half-bridge unit are both arranged adjacent to the second diagonal line.

3. The power conversion device of claim 2, wherein a half-bridge capacitor and a half-bridge switch in the first half-bridge unit are respectively arranged on two opposite surfaces of the circuit substrate; and a half-bridge capacitor and a half-bridge switch in the second half-bridge unit are respectively arranged on two opposite surfaces of the circuit substrate.

4. The power conversion device of claim 1, wherein numbers of synchronous switches included in the first half-bridge unit and the second half-bridge unit are both two, the two synchronous switches of the first half-bridge unit are arranged on the first surface, and the two synchronous switches of the second half-bridge unit are arranged on the second surface.

5. The power conversion device of claim 4, wherein a projection on the first surface of the two synchronous switches arranged on the first surface is at least partially overlapped with a projection on the first surface of the corresponding two synchronous switches arranged on the second surface.

6. The power conversion device of claim 1, wherein each of the first half-bridge unit and the second half-bridge unit further comprises an output negative pin, the output negative pin in the first half-bridge unit is arranged adjacent to the first side edge, the output negative pin in the second half-bridge unit is arranged adjacent to the third side edge, and the output negative pin in the first half-bridge unit and the output negative pin in the second half-bridge unit are arranged adjacent to the first diagonal.

7. The power conversion device of claim 6, wherein the output negative pins in the first half-bridge unit and the second half-bridge unit are arranged to be at least one of the following:
the output negative pin in the first half-bridge unit is arranged adjacent to a synchronous switch in the first half-bridge unit, and
an output negative pin in the second half-bridge unit is arranged adjacent to a synchronous switch in the second half-bridge unit.

8. The power conversion device of claim 1, wherein each of the first half-bridge unit and the second half-bridge unit further comprises an output positive pin, the output positive pin in the first half-bridge unit is arranged adjacent to the third side edge, the output positive pin in the second half-bridge unit is arranged adjacent to the first side edge, and the output positive pin in the first half-bridge unit and the output positive pin in the second half-bridge unit are arranged adjacent to the second diagonal line.

9. The power conversion device of claim 1, wherein the magnetic part further comprises four primary windings and four secondary windings, the magnetic core comprises four winding columns, the four primary windings are wound on the four winding columns respectively, and the four secondary windings are wound on the four winding columns respectively.

10. The power conversion device of claim 9, wherein the magnetic core is buckled with the circuit substrate, and the four winding columns are arranged around the middle column, the four winding columns are respectively a first winding column, a second winding column, a third winding column and a fourth winding column, the first winding column is arranged adjacent to the first side edge and the second side edge, the second winding column is arranged adjacent to the second side edge and the third side edge, the third winding column is arranged adjacent to the first side edge and the fourth side edge, and the fourth winding column is arranged adjacent to the third side edge and the fourth side edge, wherein the four primary windings are respectively a first primary winding, a second primary winding, a third primary winding and a fourth primary winding, wherein the four secondary windings are respectively a first secondary winding, a second secondary winding, a third secondary winding and a fourth secondary winding, wherein a second end of the first primary winding is electrically connected with a first end of the second primary winding, and a second end of the third primary winding is electrically connected with a first end of the fourth primary winding, wherein a second end of the first secondary winding is electrically connected with a first end of the second secondary winding, and a second end of the third secondary winding is electrically connected with a first end of the fourth secondary winding.

11. The power conversion device of claim 10, wherein a first channel is formed between the first winding column and the third winding column, a second channel is formed between the first winding column and the second winding column, a third channel is formed between the second winding column and the fourth winding column, and a fourth channel is formed between the fourth winding column and the third winding column, wherein the first primary winding is electrically connected with the second primary winding in series, and the first primary winding and the second primary winding are wound on the first winding column and the second winding column in an 8-shaped manner, wherein the third primary winding and the fourth primary winding are electrically connected in series, and the third primary winding and the fourth primary winding are wound on the third winding column and the fourth winding column in an 8-shaped manner, wherein the first secondary winding is electrically connected with the second secondary winding, and is wound on the first winding column and the second winding column in an 8-shaped manner, wherein the third secondary winding is electrically connected with the fourth secondary winding, and is wound on the third winding column and the fourth winding column in an 8-shaped manner.

12. The power conversion device of claim 11, wherein the power conversion device further comprises an output positive pin, wherein a first end of the first primary winding and a second end of the second primary winding are arranged close to the third side edge, the first end of the first primary winding is electrically connected with the half-bridge switch in the same half-bridge unit, and the second end of the second primary winding is electrically connected with the half-bridge capacitor in the same half-bridge unit, wherein a first end of the third primary winding and a second end of the fourth primary winding are arranged close to the first side edge, the first end of the third primary winding is electrically connected with the half-bridge switch in the same half-bridge unit, and the second end of the fourth primary winding is electrically connected with the half-bridge capacitor in the same half-bridge unit; wherein a first end of the first secondary winding, a second end of the second secondary winding, the second end of the third secondary winding and the first end of the fourth secondary winding are arranged close to the first side edge, and the second end of the first secondary winding, the first end of the second secondary winding, the first end of the third secondary winding and the second end of the fourth secondary winding are arranged close to the third side edge, wherein the first end of the first secondary winding, the second end of the second secondary winding, the first end of the third secondary winding and the second end of the fourth secondary winding are electrically connected to one of the synchronous switches, the second end of the first secondary winding, the first end of the second secondary winding, the second end of the third secondary winding and the first end of the fourth secondary winding are electrically connected to an output positive pin.

13. A magnetic assembly, comprising: a magnetic core, a primary winding, a first secondary winding and a second secondary winding, wherein the magnetic core comprises a first side face and a third side face opposite to each other, a second side face and a fourth side face opposite to each other, a first winding column, a second winding column and a middle column, wherein the first winding column is arranged adjacent to the first side face, the second winding column is arranged adjacent to the third side face, and the middle column is arranged adjacent to the fourth side face,
wherein a first end and a second end of the primary winding are arranged close to the third side,
wherein the primary winding is wound around the first winding column and the second winding column from the first end to the second end, and a winding direction of the primary winding from the first end to the second end on the first winding column is opposite to a winding direction on the second winding column, wherein a second end of the first secondary winding and a first end of the second secondary winding are short-circuited at a node adjacent to the third side, wherein the first end of the first secondary winding and a second end of the second secondary winding are arranged adjacent to the first side, and the secondary winding is wound around the first winding column and the second winding column from the first end to the second end of the second secondary winding.

14. The magnetic assembly of claim 13, wherein the first end of the primary winding is arranged between the second winding column and the fourth side, and the second end of the primary winding is arranged between the second winding column and the second side.

15. The magnetic assembly of claim 13, wherein the first end of the first secondary winding is arranged between a first winding column and the second side face, and the second end of the second secondary winding is arranged between the first winding column and the fourth side face.

16. The magnetic assembly of claim 14, wherein a first end of the primary winding is electrically connected to two switching elements.

17. The magnetic assembly of claim 16, wherein the second end of the primary winding is electrically connected to two capacitor elements.

18. The magnetic assembly of claim 15, wherein the first end of the first secondary winding and the second end of the second secondary winding are both electrically connected to a switching element.

19. The magnetic assembly of claim 15, wherein short contacts of the first secondary winding and the second secondary winding are electrically connected to a capacitor element.
